(19) United States
(12) Patent Application Publication
(10) Pub. No.: US 2026/0051145 A1
(43) Pub. Date: Feb. 19, 2026

(54) KEY-POINT ASSOCIATING APPARATUS, KEY-POINT ASSOCIATING METHOD, AND NON-TRANSITORY COMPUTER-READABLE STORAGE MEDIUM

(71) Applicant: NEC Corporation, Minato-ku, Tokyo (JP)

(72) Inventor: Yadong PAN, Tokyo (JP)

(73) Assignee: NEC Corporation, Minato-ku, Tokyo (JP)

(21) Appl. No.: 19/129,793

(22) PCT Filed: Dec. 5, 2022
(86) PCT No.: PCT/JP2022/044736

§ 371 Date: May 14, 2025

(51) Int. Cl. G06V 10/46; G06V 10/74; G06V 10/75; G06V 10/77; G06V 40/10

(52) U.S. Cl. CPC G06V 10/462; G06V 10/758; G06V 10/761; G06V 10/7715; G06V 40/103

(57) ABSTRACT

A key-point associating apparatus acquires a target image on which one or more persons are captured, detects key-points from the target image, and generates a spatial feature map for each one of pairs of the body parts. The spatial feature map includes a first direction region for each key-point that represents a first body part of the corresponding pair and the second direction region for each key-points that represents a second body part of the corresponding pair. The first and second direction regions belonging to a same person as each other represent a direction from the key-point of the first direction region to the key-point of the second direction region. The key-point associating apparatus generates a key-point group for each one of the persons captured on the target image.

### TECHNICAL FIELD

The present disclosure generally relates to a key-point associating apparatus, a key-point associating method, and a non-transitory computer-readable storage medium.

### BACKGROUND ART

There are various types of analysis that are performed on an image on which one or more persons are captured. Some of those analyses, such as pose estimation, use key-points of the person. Specifically, the key-points are detected from the image, and divided into groups so that each group includes the key-points that belong to the same person as each other. This process of dividing the key-points into groups is called “key-point association”.

NPL1 discloses one of algorithms for key-point association. For each one of predefined pairs of body parts, a system of NPL1 generates a feature map that includes a region called Part Affinity Field (PAF) corresponding to that pair of the body parts for each person from an input image. The PAF corresponding to a pair of the body parts connects two key-points representing that pair of the body parts and belonging to the same person as each other, and is filled with a pixel value that represents the direction between those two key-points.

### CITATION LIST

### Non Patent Literature

NPL1: Zhe Cao, Gines Hidalgo, Tomas Simon, Shih-En Wei, and Yaser Sheikh, “OpenPose: Realtime Multi-Person 2D Pose Estimation using Part Affinity Fields”, [online], Dec. 18, 2018, [retrieved on 2022 Apr. 29], retrieved from <arXiv, https://arxiv.org/pdf/1812.08008.pdf>

### SUMMARY OF INVENTION

### Technical Problem

Since the PAF has to connect two key-points corresponding thereto, the PAF could include a region that is apart from both of those key-points, such as a region around the middle point between those key-points. An objective of the present disclosure is to provide a novel technique of key-point association.

### Solution to Problem

The present disclosure provides a key-point associating apparatus comprising at least one memory that is configured to store instructions and at least one processor.

The at least one processor is configured to execute the instructions to: acquire a target image on which one or more persons are captured; detect key-points of the persons from the target image for each one of body parts of the person: generate a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and generate a key-point group, which includes the key-points of a same person as each other, for each one of the persons captured on the target image.

The present disclosure further provides a key-point associating method performed by a computer.

The key-point associating method comprises: acquiring a target image on which one or more persons are captured: detecting key-points of the persons from the target image for each one of body parts of the person: generating a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and generating a key-point group, which includes the key-points of a same person as each other, for each one of the persons captured on the target image.

The present disclosure further provides a non-transitory computer readable storage medium storing a program.

The program causes a compute to execute: acquiring a target image on which one or more persons are captured: detecting key-points of the persons from the target image for each one of body parts of the person: generating a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and generating a key-point group, which includes the key-points of a same person as each other, for each one of the persons captured on the target image.

### Advantageous Effects of Invention

According to the present disclosure, a novel technique of key-point association is provided.

### BRIEF DESCRIPTION OF DRAWINGS

FIG. 1 illustrates an overview of a key-point associating apparatus.

FIG. 2 illustrates an example of the spatial feature map.

FIG. 3 is a block diagram illustrating an example of a functional configuration of the key-point associating apparatus.

FIG. 4 is a block diagram illustrating an example of a hardware configuration of the key-point associating apparatus.

FIG. 5 is a flowchart illustrating an example flow of processes performed by the key-point associating apparatus.

FIG. 6 illustrates an example structure of the feature generating unit.

FIG. 7 illustrates an example of a pair of the horizontal spatial feature map and the vertical spatial feature map by which the direction between the key-points in a 3D space is represented.

FIG. 8 illustrates an example structure of the feature generating unit in the case where the position of the key-point is represented by 3D coordinates.

FIG. 9 illustrates an example way of key-point association.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage device to which a computer using that information has access unless otherwise described.

### Overview

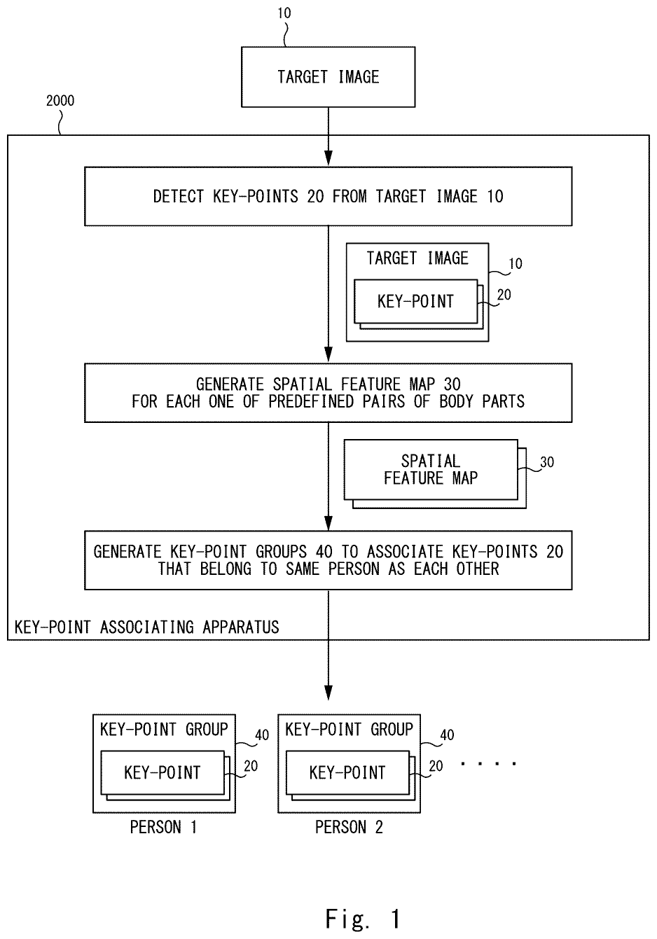

FIG. 1 illustrates an overview of a key-point associating apparatus 2000 of an example embodiment. It is noted that the overview illustrated by FIG. 1 shows an example of operations of the key-point associating apparatus 2000 to make it easy to understand the key-point associating apparatus 2000, and does not limit or narrow the scope of possible operations of the key-point associating apparatus 2000.

The key-point associating apparatus 2000 acquires a target image 10 in which one or more persons are captured, detects key-points 20 from the target image 10, and performs key-point association on the detected key-points 20. The target image 10 may be arbitrary type of image data, such as RGB image or grayscale image, in which persons can be captured in a visible manner.

The key-point 20 may indicate a position of a body part of a person captured on the target image 10. The position of the body part may be represented by 2-dimentional (2D) coordinates on an image plane of the target image 10 or 3-dimensional (3D) coordinates in a specific 3D space. The key-point associating apparatus 2000 is configured to detect one or more key-points 20 for each one of predefined body parts from the target image 10. The predefined body parts may include a neck, right and left eyes, right and left ears, right and left shoulders, right and left elbows, right and left wrists, a waist, right and left knees, and right and left foots.

The key-point association is a process to generate a group called “key-point group 40” for each person included in the target image 10. The key-point group 40 of a particular person includes only the key-points 20 that belong to the particular person.

In order to generate the key-point group 40 for each person, the key-point associating apparatus 2000 generates a spatial feature map 30 for each one of predefined pairs of the body parts based on the target image 10. The predefined pairs of the body parts may include pairs of adjacent body parts, such as a pair of the right eye and the neck, a pair of the neck and the right shoulder, a pair of the right shoulder and the right elbow, a pair of the right elbow and the right wrist, etc. It is noted that the body parts of a specific pair are not necessarily adjacent to each other.

The spatial feature map 30 of a particular pair of the body parts may be an image data that has the same dimension as the target image 10, and includes a region called “direction region” for each one of the key-points 20 that indicates one of the body parts of that particular pair. The direction regions that belong to the same person as each other are generated so as to indicate the direction between those key-points 20 (the direction from one of those key-points 20 to the other key-point 20). In some implementations, different colors (in other words, pixel values) are assigned to different directions. In this case, the direction region is filled with the color corresponding to the direction to be represented by that direction region. Regions not included in any direction regions may be filled with a color that is not assigned to any directions.

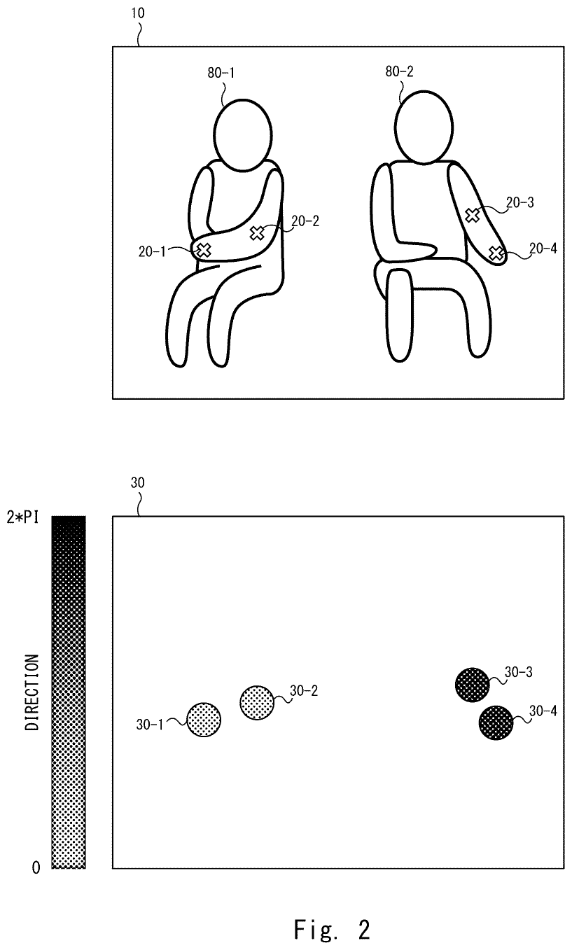

FIG. 2 illustrates an example of the spatial feature map 30. The target image 10 shown by FIG. 2 includes two persons 80. The spatial feature map 30 shown by FIG. 2 is generated for a pair of the left elbow and the left wrist. Thus, the spatial feature map 30 includes four direction regions 32-1 to 32-4, which represents the left elbow of the person 80-1, the left wrist of the person 80-1, the left elbow of the person 80-2, and the left wrist of the person 80-2, respectively.

In FIG. 2, the direction region 32 represents a direction from the left elbow to the left wrist of the corresponding person 80. For example, the direction regions 32-1 and 32-2, which correspond to the person 80-1, represent the direction from the left elbow to the left wrist of the person 80-1. Since the left elbow and the left wrist of the person 80-1 are represented by the key-points 20-1 and 20-2, respectively, the direction regions 32-1 and 32-2 represent the direction from the key-point 20-1 to the key-point 20-2.

After generating the spatial feature maps 30, the key-point associating apparatus 2000 divides the key-points 20 into the key-point groups 40 based on the spatial feature maps 30. Specific ways to generate the key-point groups 40 will be explained later.

### Example of Advantageous Effect

According to the key-point associating apparatus 2000, the key-points 20 detected from the target image 10 are classified into the key-point groups 40 so that each key-point group 40 includes only the key-points 20 that belong to the same person as each other. To do so, the key-point associating apparatus 2000 generates the spatial feature map 30 for each one of the predefined pairs of the body parts. Thus, by the key-point associating apparatus 2000, a novel technique for key-point association is provided.

In addition, the key-point associating apparatus 2000 is advantageous in the following point. As described above, NPL1 generates, for each one of pairs of the body parts, a feature map including the PAF that connects two key-points corresponding to that pair for each person. This feature map is generated using a convolutional neural network (CNN). Since the PAF could include a region that is apart from both of the corresponding key-points (e.g., a region in the middle of those key-points), the training of the CNN could suffer from the slow convergence of such the region in the PAF.

In this regard, the spatial feature map 30 of a pair of the body parts includes separate direction regions 32 for two key-points of that pair for each person. Thus, a region apart from the key-points, such a region in the middle of the key-points, is not included in the direction region 32. Thus, in the case where the spatial feature map 30 is generated by a machine learning-based model, it can prevent the training of the model from being suffered from the slow convergence of the regions apart from the key-points.

Hereinafter, more detailed explanation of the key-point associating apparatus 2000 will be described.

### Example of Functional Configuration

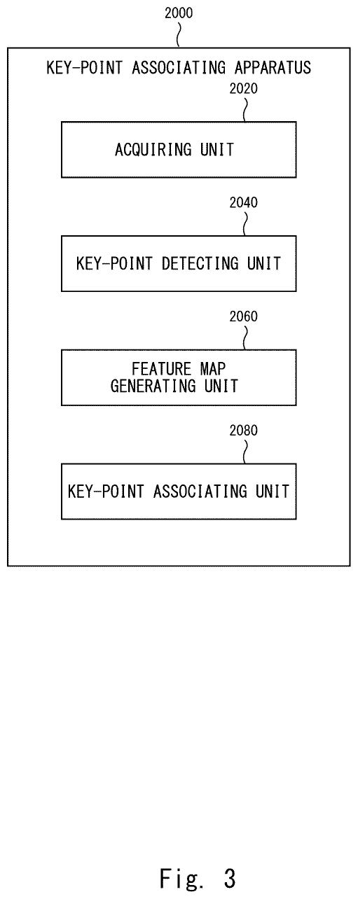

FIG. 3 is a block diagram illustrating an example of the functional configuration of the key-point associating apparatus 2000 of the example embodiment. The key-point associating apparatus 2000 includes an acquiring unit 2020, a key-point detecting unit 2040, a feature map generating unit 2060, and a key-point associating unit 2080. The acquiring unit 2020 acquires the target image 10. The key-point detecting unit 2040 detects the key-points 20 from the target image 10. The feature map generating unit 2060 uses the target image 10 to generate the spatial feature map 30 for each one of the predefined pairs of the body parts. The key-point associating unit 2080 generates the key-point groups 40 based on the spatial feature maps 30.

### Example of Hardware Configuration

The key-point associating apparatus 2000 may be realized by one or more computers. Each of the one or more computers may be a special-purpose computer manufactured for implementing the key-point associating apparatus 2000, or may be a general-purpose computer like a personal computer (PC), a server machine, or a mobile device.

The key-point associating apparatus 2000 may be realized by installing an application in the computer. The application is implemented with a program that causes the computer to function as the key-point associating apparatus 2000. In other words, the program is an implementation of the functional units of the key-point associating apparatus 2000.

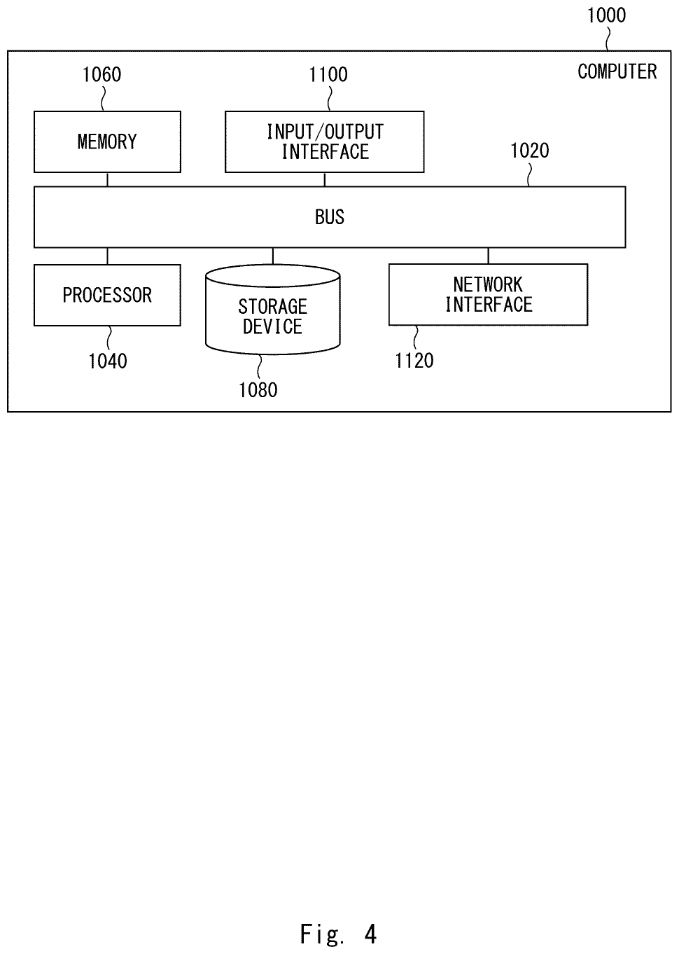

FIG. 4 is a block diagram illustrating an example of the hardware configuration of a computer 1000 realizing the key-point associating apparatus 2000 of the example embodiment. In FIG. 4, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), DSP (Digital Signal Processor), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The processor 1040 is configured to load instructions of the above-mentioned program from the storage device 1080 into the memory 1060 and executes those instructions so as to cause the computer 1000 to operate as the key-point associating apparatus 2000.

The hardware configuration of the computer 1000 is not restricted to that shown in FIG. 4. For example, as mentioned-above, the key-point associating apparatus 2000 may be realized as a combination of multiple computers. In this case, those computers may be connected with each other through the network.

### <Flow of Process>

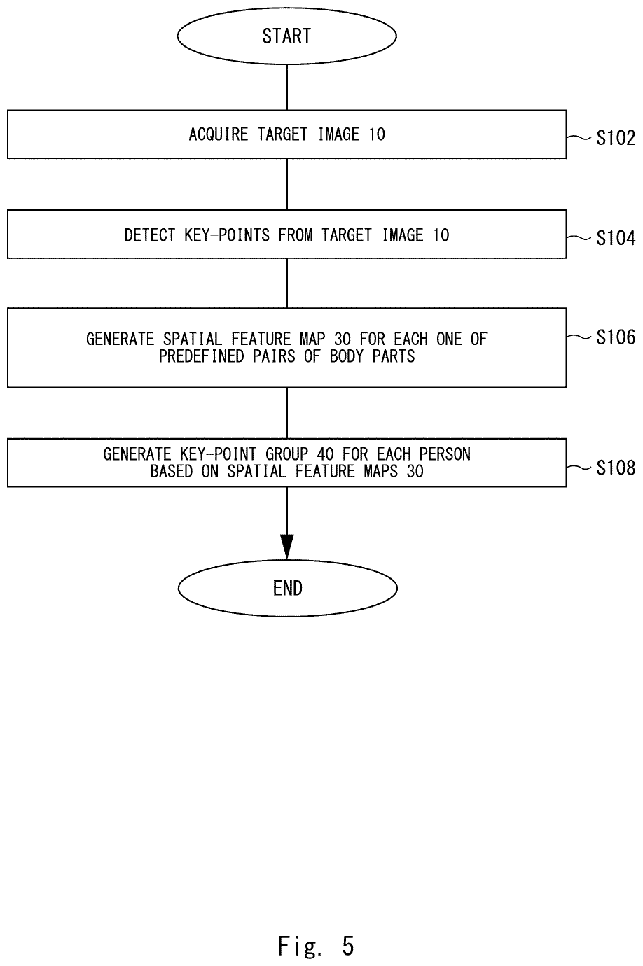

FIG. 5 is a flowchart illustrating an example flow of processes performed by the key-point associating apparatus 2000 of the example embodiment. The acquiring unit 2020 acquires the target image 10 (S102). The key-point detecting unit 2040 detects the key-points from the target image 10 (S104). The feature map generating unit 2060 generates the spatial feature map 30 for each one of the predefined pairs of the body parts (S106). The key-point associating unit 2080 generates the key-point groups 40 for each person (S108).

### <Acquisition of Target Image 10: S102>

The acquiring unit 2020 acquires the target image 10 (S102). There are various ways to acquire the target image 10. In some embodiments, the target image 10 is stored in advance in a storage device in a manner that the key-point associating apparatus 2000 can acquire it. In this case, the acquiring unit 2020 may access the storage device to acquire the target image. In other embodiments, the target image 10 may be sent by another computer, such as a camera that generates the target image 10. In this case, the acquiring unit 2020 may acquire the target image 10 by receiving it.

In some embodiments, the target image 10 may be one of time-series images, such as time-series video frames constituting a video. In this case, the key-point associating apparatus 2000 may acquire all or a part of the time-series images as the target images 10, and perform key-point detection and key-point association for each of the target images 10.

### <Detection of Key-points: S104>

The key-point detecting unit 2040 detects the key-points 20 from the target image 10 (S104). There are various ways to detect one or more positions of predefined parts of human's body as key-points from an image, and the key-point detecting unit 2040 may use one of those ways to detect the key-points 20 from the target image 10.

In some embodiments, the key-point detecting unit 2040 includes a machine learning-based model (e.g., a neural network) that is configured to take an image as input and that has been trained in advance to detect one or more key-points 20 for each one of the predefined parts from the input image in response to the input image being input thereto. Hereinafter, this model is called “key-point detecting model”.

The key-point detecting model may take the target image 10 as input, extract features from the target image 10, detect one or more positions of each one of the predefined body parts based on the extracted features, and output pairs of the position and the label as key-points. The label of the key-point indicates which body part is indicated by that key-point. In this case, the key-point detecting model may include a first model that is trained in advance to extract the features from the target image 10, and a second model that is trained in advance to detect one or more positions of each one of the predefined body parts based on the features extracted by the first model. Each of the first model and the second model may be configured as a machine learning-based model, such as a neural network. It is noted that there are various types of machine-learning models that can detect key-points from an input image, and the key-point detecting model can be configured as one of such models.

### <Generation of Spatial Feature Map: S106>

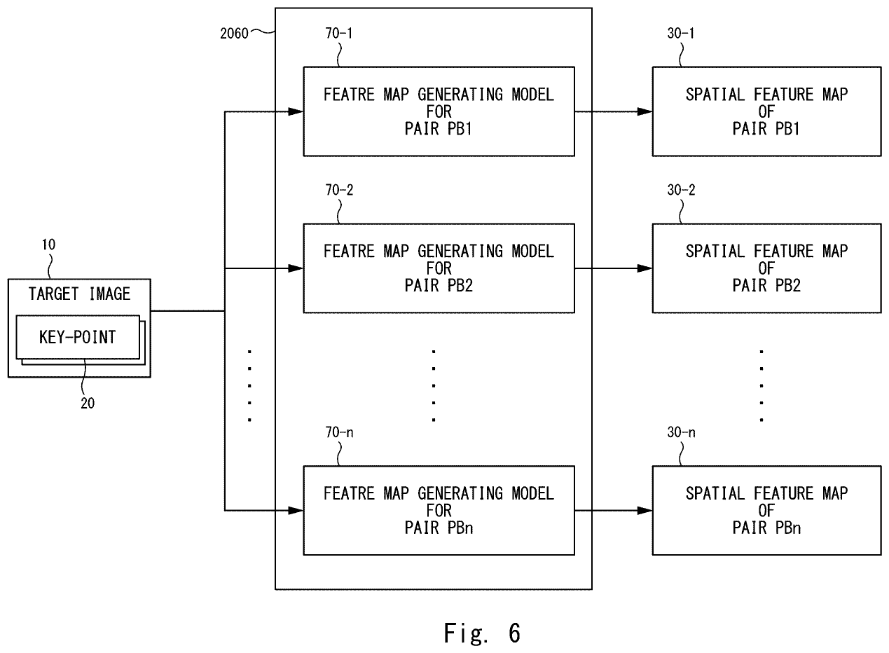

The feature map generating unit 2060 generates the spatial feature map 30 for each one of the predefined pairs of the body parts (S106). In order to generate the spatial feature map 30, the feature map generating unit 2060 may include a machine learning-based model called “feature map generating model” for each one of the predefined pairs of the body parts. FIG. 6 illustrates an example structure of the feature generating unit 2060. In FIG. 6, it is assumed that N pairs of the body parts are predefined. Thus, the feature map generating unit 2060 includes the feature map generating models 70 for each one of N predefined pairs of the body parts.

The feature map generating model 70 of a particular pair of the body parts is configured to take, as input, an image data and the information of the key-points 20 that are detected from the image data and represent one of the body parts of that pair. The feature map generating model 70 has been trained in advance to generate the spatial feature map 30 for the corresponding pair of the body parts in response to the input data being input thereto.

When the position of the key-point 20 is represented by 2D coordinates, as illustrated by FIG. 6, the feature map generating unit 2060 may generate one spatial feature map 30 for each one of the predefined pairs of the body parts since the direction between two key-point 20 may be represented by a single angle: e.g., an angle between X-axis and the line connecting those two key-points 20. On the other wrist, when the position of the key-point 20 is represented by 3D coordinates, the feature map generating unit 2060 may generate two spatial feature maps 30 for each one of the predefined pairs of the body parts since the direction between two key-point 20 may be represented by a pair of angles. Hereinafter, the case where the position of the key-point 20 is represented by 3D coordinates is explained in more detail.

When the position of the key-point 20 is represented by 3D coordinates, the direction between two key-points 20 can be represented by a pair of a horizontal direction and a vertical direction. To represent a direction between the key-points 20 in a 3D space by a pair of the horizontal direction and the vertical direction, the feature map generating unit 2060 may generates a pair of the spatial feature map 30 that represents the horizontal direction between the key-points 20 and the spatial feature map 30 that represents the vertical direction between the key-points 20. Hereinafter, the spatial feature map 30 that represents the horizontal direction between the key-points 20 is called “horizontal spatial feature map” whereas the spatial feature map 30 that represents the vertical direction between the key-points 20 is called “vertical spatial feature map”.

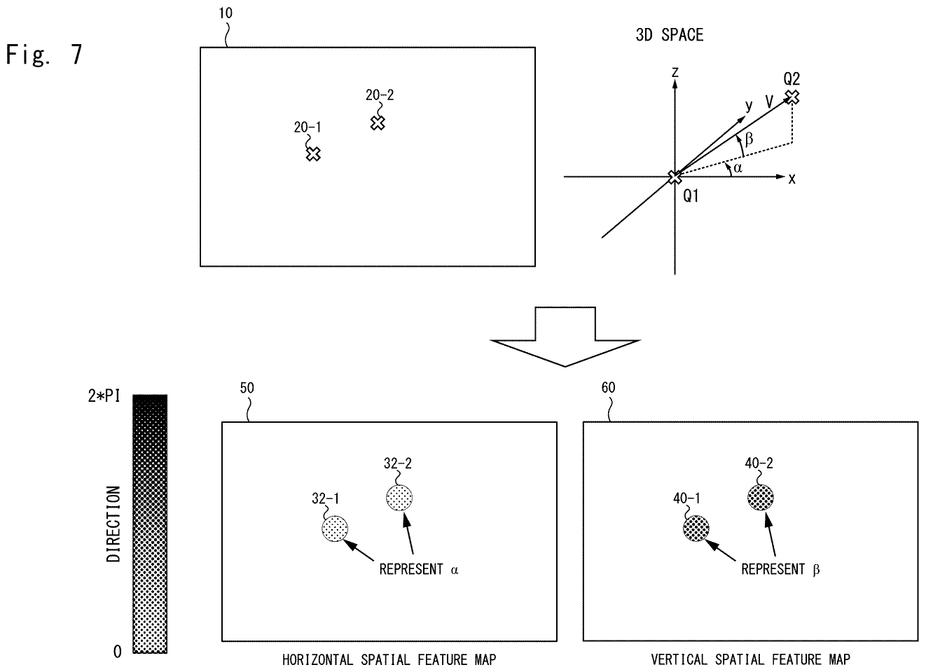

FIG. 7 illustrates an example of a pair of the horizontal spatial feature map and the vertical spatial feature map by which the direction between the key-points 20 in a 3D space is represented. In FIG. 7, it is assumed that the spatial feature map 30 is generated for a pair of the left elbow and the left wrist. In addition, it is assumed that a key-point 20-1 and a key-point 20-2 represent positions of the left elbow and the left wrist of a person, respectively.

The position of the key-point 20-1 and the position of the key-point 20-2 in a 3D space are represented by points Q1 and Q2. Thus, the direction from the key-point 20-1 to the key-point 20-2 in the 3D space is represented by a vector V whose initial point and terminal point are Q1 and Q2, respectively.

The horizontal direction of the vector V can be represented by an angle between the X-axis and a projection of the vector V on the X-Y plane. This angle is denoted by α in FIG. 7. Thus, the horizontal spatial feature map 50 is generated to include the direction regions 32-1 and 32-2 each of which represents the angle α with its pixel values.

The vertical direction of the vector V can be represented by an angle between the X-Y plane and the vector V. This angle is denoted by β in FIG. 7. Thus, the vertical spatial feature map 60 is generated to include the direction regions 32-3 and 32-4 each of which represents the angle β with their pixel values.

When the position of the key-point 20 is represented by 3D coordinates, for each one of the predefined pairs of the body parts, the feature map generating model 70 may include a first model that generates the horizontal spatial feature map 50 for that pair of the body parts and a second model that generates the vertical spatial feature map 60 for that pair of the body parts are included in the feature map generating unit 2060. By using those feature generating models, the feature map generating unit 2060 can generate the pair of the horizontal spatial feature map 50 and the vertical spatial feature map 60 for each one of the predefined pairs of the body parts from the target image 10 and the key-points 20 detected from the target image 10.

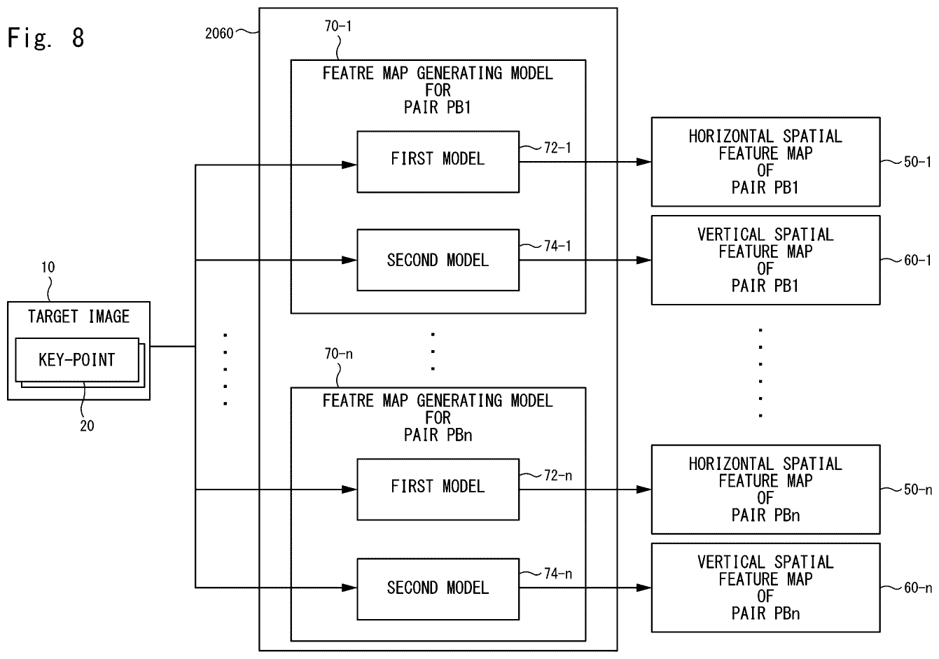

FIG. 8 illustrates an example structure of the feature map generating unit 2060 in the case where the position of the key-point 20 is represented by 3D coordinates. Each feature map generating model 70 includes a pair of the first model 72 that generates the horizontal spatial feature map 50 and the second model 74 that generates the vertical spatial feature map 60.

### <Key-point Association: S108>

The key-point associating unit 2080 generates the key-point groups 40 based on the spatial feature maps 30, thereby performing key-point association (S108). As mentioned above, the key-point group 40 is generated so as to include only the key-points 20 that belong to the same person as each other. Suppose that the number of the persons captured on the target image 10 is N. In this case, the key-point associating unit 2080 may generate the key-point group 40 for each one of the N persons. Thus, N key-point groups 40 may be generated.

Hereinafter, specific ways to perform key-point association using the spatial feature maps 30 will be explained. For the sake of brevity, it is first assumed that the position of the key-point 20 is represented by 2D coordinates. How to perform key-point association in the case where the position of the key-point 20 is represented by 3D coordinates will be described later.

For each one of the predefined pairs of the body parts, the key-point associating unit 2080 uses the spatial feature map 30 of that pair to divide the key-points 20 into the key-point groups 40. For example, the key-point associating unit 2080 uses the spatial feature map 30 of the pair of the left elbow and the left wrist to generate the key-point groups 40 each of which includes pairs of the key-point 20 of the left elbow and the key-point 20 of the left wrist that belong to the same person as each other.

Theoretically, a pair of direction regions 32 in the spatial feature map 30 correspond to a pair of two key-points 20 that belong to the same person as each other when those two direction regions 32 indicate the same direction as each other. Thus, the key-points associating unit 2080 can determine a pair of the key-points 20 that belong to the same person as each other by determining a pair of the key-points 20 whose direction regions 32 indicate the same direction as each other.

However, in reality, there may be some difference between the directions indicated by the direction regions 32 that belong to the same person as each other. Thus, in some implementations, the key-point associating unit 2080 determines a pair of the key-points 20 whose direction regions 32 indicate the directions substantially close to each other, and then generates a key-point group 40 that includes the determined pair of the key-points 20.

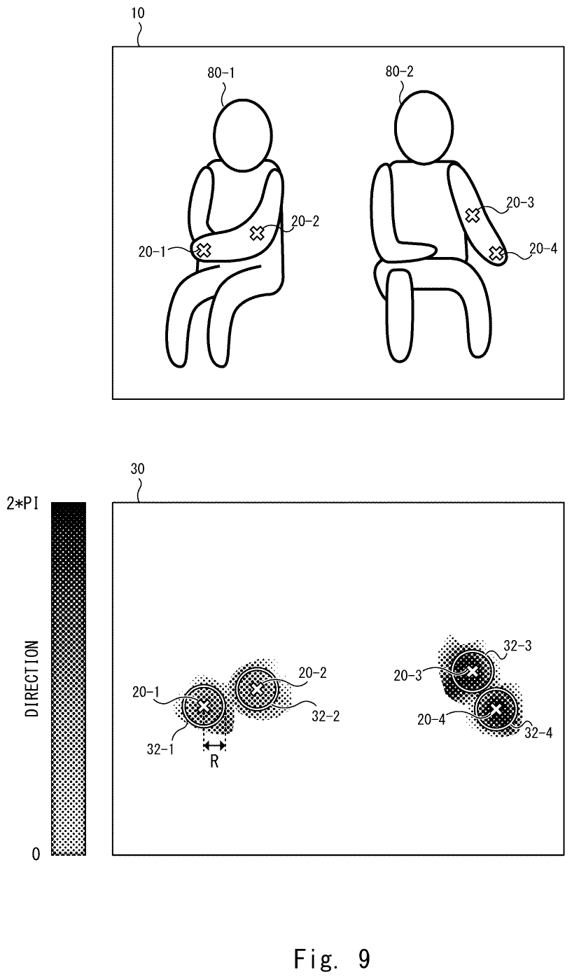

FIG. 9 illustrates an example way of key-point association. In this example, the spatial feature map of the pair of the left elbow and the left wrist is used. Thus, the key-point group 40 that includes a pair of the key-point 20 indicating the left elbow and the key-point 20 indicating the left wrist is generated for each person captured on the target image 10.

By referring to the result of the detection of the key-points 20 performed by the key-point detecting unit 2040, the key-point associating unit 2080 determines the key-points 20 of the left elbows (key-points 20-2 and 20-3) and the key-points 20 of the left wrists (key-points 20-1 and 20-4) on the spatial feature map 30. Then, the key-point associating unit 2080 determines the direction region 32 for each one of the determined key-points 20. Specifically, there are four direction regions 32-1 to 32-4 that correspond to the key-points 20-1 to 20-4, respectively.

As described in detail later, the feature map generating model 70 may be trained to generate the spatial feature map 30 in which the direction region 32 has a predefined shape and size and the position of the direction region 32 is defined based on the position of the corresponding key-point 20. Thus, the key-points associating unit 2080 can determine the direction region 32 based on its predefined shape and size and the position of its corresponding key-point 20.

In the example shown by FIG. 9, it is assumed that the shape of the direction region 32 is defined as the circle and the size of the direction region 32 is defined by the radius R. In addition, it is assumed that the center of the direction region 20 is located at the corresponding key-point 20. Thus, for each key-point 20, the key-point associating unit 2080 determines a region whose shape is the circle, whose radius is R, and whose center location is at that key-point 20 as the direction region 32 corresponding to that key-point 20.

It is noted that when two or more direction regions 32 overlap each other, the key-point associating unit 2080 may adjust the size of the direction regions 32 so that they do not overlay each other. There are various ways to adjust the size of the direction region. For example, the key-point associating unit 2080 may repeatedly multiply the size of the direction regions 32 by an adjustment factor, which is a real number greater than 0 and less than 1, to reduce their size until they do not overlap each other. In another example, two or more options of the size of the direction region 32 are defined in advance. In this case, the key-point associating unit 2080 may choose the largest option of the size of the direction regions 32 with which the direction regions 32 do not overlap each other.

It is also noted that, as described later, the adjustment of the size of the direction region 32 may also be performed to generate a training dataset to be used to train the feature generating models. Thus, it is preferable that the key-point associating unit 2080 adjusts the size of the direction region 32 in the same way as the way by which the size of the direction region 32 is adjusted to generate the training dataset.

After determining the direction region 32 for each key-point 20, the key-point associating unit 2080 determines pairs of the key-points 20 to generate the key-point groups 40. To make it easy to explain operations of the key-point associating unit 2080, the body parts of the pair corresponding to the spatial feature map 30 are called the first body part and the second body part, respectively. For example, in the example shown by FIG. 9, the left elbow is called the first body part whereas the left wrist is called the second body part.

The key-point associating unit 2080 chooses one of the key-point 20 of the first body part. Then, the key-point associating unit 2080 evaluates the key-points 20 of the second body part with respect to the chosen key-point 20 of the first body part in order to determine which one of the key-point 20 of the second body part is to be paired with the chosen key-point 20 of the first pair.

For example, in the example shown by FIG. 9, the key-point associating unit 2080 may choose the key-point 20-2, as one of the key-points 20 of the left elbow. Then, the key-point associating unit 2080 evaluates each one of the key-points 20 of the left wrist (i.e., key-points 20-1 and 20-4) to determine which one of them is to be paired with the key-point 20-2.

The key-point 20 may be evaluated using an index value called “coefficient distance”. The coefficient distance between two key-points 20 represents how much different the directions represented by their corresponding direction regions are. For example, the coefficient distance between the key-point 20-2 and the key-point 20-1 represents a degree of difference between the direction represented by the direction region 32-2 and the direction represented by the direction region 32-1.

After choosing one of the key-point 20 of the first body part, the key-point associating unit 2080 computes, for each one of the key-points 20 of the second body part, the coefficient distance between that key-point 20 of the second body part and the chosen key-point 20 of the first body part. Then, the key-point associating unit 2080 makes a pair of the chosen key-point 20 of the first body part and the key-point 20 of the second body part that has the smallest coefficient distance.

In some implementations, a threshold of the coefficient distance may be predefined. In this case, the key-point 20 of the second body part that has the smallest coefficient distance is paired with the chosen key-point 20 of the first body part when its coefficient distance is smaller than the threshold of the coefficient distance.

To compute the coefficient distance between the key-points 20, the key-point associating unit 2080 determines a value representing the direction (hereinafter, called “direction value”), for each one of those direction regions 32. As mentioned above, the direction region may represent the direction by the values of pixels within it. Thus, the key-point associating unit 2080 may compute a statistical value of the pixel values within the direction region 32 as the direction value of that direction region 32.

The coefficient distance between the key-points 20 may be represented by an absolute value of the difference between the direction values of their corresponding direction regions 32. This can be formulated as follows:

$$\begin{matrix}Equation 1 & \\ C ( k 1 , k 2 ) = abs ( dv ( k 1 ) - dv ( k 2 ) ) & ( 1 )\end{matrix}$$

where k1 and k2 represents the key-points 20 for which the coefficient distance is computed: C(k1,k2) represents the coefficient distance between the key-points k1 and k2; abs(x) represents the absolute value of x; and dv(k) represents the direction value of the direction region 32 corresponding to the key-point k.

In some implementations, the coefficient distance between the key-points 20 may be computed taking the Euclid distance between those key-points 20 into account. This is because the longer the Euclid distance between the key-points 20 is, the less likely those key-points 20 are to belong to the same person as each other. When the Euclid distance between the key-points 20 is taken into consideration, the coefficient distance between the key-points 20 can be formulated as follows:

$$\begin{matrix}Equation 2 & \\ C ( k 1 , k 2 ) = abs ( dv ( k 1 ) - dv ( k 2 ) ) * D ( k 1 , k 2 ) & ( 2 )\end{matrix}$$

where D(k1,k2) represents the Euclid distance between the key-points k1 and k2.

After performing the generation of the key-point groups 40 for each one of predefined pairs of the body parts, the key-point associating unit 2080 may combines the key-point groups 40 that correspond to the same person as each other. Specifically, until no key-point group 40 includes the same key-point 20 as another key-point group 40, the key-point associating unit 2080 may repeatedly perform: detecting two the key-point groups 40 that includes at least one same key-point 20 as each other; and combining the detected two key-point groups 40 into a single key-point group 40.

### <<As to Case Where Position of Key-Point is Represented by 3D Coordinates>>

In the case where the position of the key-point is represented by 3D coordinates, two types of the spatial feature map 30, i.e., the horizontal spatial feature map 50 and the vertical spatial feature map 60, are generated for each one of the predefined pairs of the body parts. Thus, for each one of the predefined pairs of the body parts, the key-point associating unit 2080 uses the horizontal spatial feature map 50 and the vertical spatial feature map 60 of that pair of the body parts to generate the key-point groups 40.

The key-point association in the case where the position of the key-point 20 is represented by 3D coordinates is different from that in the case where the position of the key-point 20 is represented by 2D coordinates in that the coefficient distance is computed based on the horizontal direction and the vertical direction between the key-points 20. To do so, the key-point associating unit 2080 computes, for each key-points 20, the direction value of the direction regions 32 in the horizontal spatial feature map 50 and that in the vertical spatial feature map 60. The coefficient distance between the key-points 20 whose positions are represented by 3D coordinates may be computed as follows:

$$\begin{matrix}Equation 3 & \\ C ( k 1 , k 2 ) = abs ( dvH ( k 1 ) - dvH ( k 2 ) ) + abs ( dvV ( k 1 ) - dvV ( k 2 ) ) & ( 3 )\end{matrix}$$

where dvH(k) represents the direction value of the direction region 32 corresponding to the key-point k in the horizontal spatial feature map 50; and dvV(k) represents the direction value of the direction region 32 corresponding to the key-point k in the vertical spatial feature map 60.

In addition, when the coefficient distance between the key-points 20 is computed taking the Euclid distance between those key-points 20 into account, the coefficient distance between the key-points 20 can be formulated as follows:

$$\begin{matrix}Equation 4 & \\ C ( k 1 , k 2 ) = \{ abs ( dvH ( k 1 ) - dvH ( k 2 ) ) + abs ( dvV ( k 1 ) - dvV ( k 2 ) ) \} * D ( k 1 , k 2 ) & ( 4 )\end{matrix}$$

<Output from Key-point Associating Apparatus 2000>

The key-point associating apparatus 2000 may be configured to output information (called output information) that shows the result of the key-point association. For example, the output information may include an identifier (e.g., frame number) of the target image 10 and key-point group information. The key-point group information includes, for each key-point group 40, an identifier of the key-point group 40 and information of each key-point 20 in the key-point group 40. The information of the key-point 20 may include an identifier of the key-point 20, the position indicated by the key-point 20, and an identifier of the body part indicated by the key-point 20.

There are various ways to output the output information. In some implementations, the output information may be put into a storage device, displayed on a display device, or sent to another computer such as a PC or smart phone of the user of the key-point associating apparatus 2000.

### <As to Training of Feature Map Generating Model 70>

The feature map generating model 70 is trained using multiple training data sets each of which includes a training input image, a ground-truth key-point information, and ground-truth spatial feature maps. The training input image is an image data on which one or more persons are captured like the target image 10. The ground-truth key-point information indicates, for each key-point 20 to be detected from the target image 10, the position and the body part indicated by that key-point 20. The ground-truth spatial feature map is an ideal spatial feature map 30 that should be output from the learnt feature map generating model 70 in response to the corresponding training input image being input thereto. The training dataset includes the ground-truth spatial feature map for each one of the predefined pairs of the body parts.

Hereinafter, an apparatus that performs a training of the feature map generating model 70 is called “training apparatus”. The training apparatus may be the same apparatus as the key-point associating apparatus 2000, or may be different apparatus from the key-point associating apparatus 2000. The former case means that the key-point associating apparatus 2000 also has a function of training the feature map generating model 70.

For each one of the predefined pairs of the body parts, the training apparatus may train the feature map generating model 70 of that pair as follows. The training apparatus provides the feature map generating model 70 with input data extracted from the training dataset, and obtains the spatial feature map 30 output by the feature map generating model 70. The training apparatus computes a loss based on the obtained spatial feature map 30 and the ground-truth spatial feature map, and updates trainable parameters of the feature map generating model 70. The above process may be repeatedly performed for each one of a plurality of the training datasets.

In some implementations, the ground-truth spatial feature map may be generated in advance by an administrator or the like of the key-point associating apparatus 2000. For example, the administrator or the like operates a computer, called “dataset generating apparatus”, to display a training input image on a display device. The dataset generating apparatus may be the same apparatus as the key-point associating apparatus 2000, may be the same apparatus as the training apparatus, or may be different apparatus from the key-point associating apparatus 2000 or the training apparatus. The first case means that the key-point associating apparatus 2000 is configured to also work as the dataset generating apparatus.

The administrator or the like operates the dataset generating apparatus to generate the training dataset. For example, the administrator or the like is given a training input image by the dataset generating apparatus. Then, for each one of the predefined pairs of the body parts, the administrator or the like specifies the key-points for each person included in the given training input image. The dataset generating apparatus generates the ground-truth spatial feature map based on the training input image and the specified key-points.

Suppose that the training input image includes persons P1 and P2. In addition, suppose that the ground-truth spatial feature map is generated for a pair of the left elbow and the left wrist. In this case, the administrator or the like may specify the key-point of the left elbow of the person P1 and the key-point of the left wrist of the person P1. Hereinafter, the key-point of the left elbow of the person P1 and the key-point of the left wrist of the person P1 are denoted by E1 and H1, respectively.

In response to the specification of the key-points E1 and H1, the dataset generating apparatus automatically generates a direction region R1 and R2 for E1 and H1, respectively. The direction region may be generated as a region having a predefined shape and size: e.g., a circle with a predefined radius, a square with a predefined length of sides, etc. The direction region of a particular key-point is located based on the position of that key-point. For example, the center of the direction region is located at the corresponding key-point: e.g., the center of the direction region of the key-point E1 is located at the key-point E1.

To generate the direction regions R1 and R2, the dataset generating apparatus computes the direction from E1 to H1 and determines a pixel value that corresponds to the computed direction. The determined pixel value is set to all the pixels in the direction regions R1 and R2.

Similarly, the administrator or the like specifies the key-point of the left elbow of the person P2 and the key-point of the left wrist of the person P2, which are denoted by E2 and H2, respectively. In response to the specification of E2 and H2, the dataset generating apparatus generates a direction region R3 and R4 for E2 and H2, respectively. Specifically, the dataset generating apparatus computes the direction from E2 to H2, determines a pixel value corresponding to the computed direction, and generates the direction regions R3 and R4 that have the predefined shape and size and that are filled with the determined pixel value.

It is noted that the dataset generating apparatus may dynamically adjust the size of the direction region in the ground-truth spatial feature map so as to prevent the direction regions from overlapping each other. Suppose that the predefined shape and size of the direction regions are the circle and the radius R, respectively. In this case, if the distance between two direction regions R1 and R2 in the ground-truth spatial feature map is less than 2*R, the direction regions R1 and R2 overlap each other. Thus, the dataset generating apparatus shrinks the direction regions R1 and R2 by reducing their size so that they do not overlap each other. Example ways of reducing the size of the direction regions are already explained above.

It is noted that, when the position of the key-point is represented by 3D coordinates, the dataset generating apparatus generates the horizontal spatial feature map and the vertical spatial feature map in response to the specification of the key-points.

### <Usage of Key-Point Group>

There are various usages of the result of the key-point association (i.e., the key-point groups 40). For example, the key-point group 40 can be used for pose estimation. As a result of the pose estimation, for each key-point group 40, the type of the pose taken by the person corresponding to the key-point group 40 can be estimated.

In addition, by performing pose estimation for each one of the target images in a time-series data (e.g., video frames in a video), a time-series of poses can be obtained for each person captured on the target images 10. The time-series of poses of the person may be used to determine an action or a time-series of actions taken by the person.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### Supplementary Notes

### Supplementary Note 1

A key-point associating apparatus comprising:
at least one memory that is configured to store instructions; and
at least one processor that is configured to execute the instructions to:
acquire a target image on which one or more persons are captured;
detect key-points of the persons from the target image for each one of body parts of the person;
generate a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and
generate a key-point group, which includes the key-points of a same person as each other, for each one of the persons captured on the target image.

### Supplementary Note 2

The key-point associating apparatus according to supplementary note 1,
wherein the generation of the key-point groups includes performing, for each one of the predefined pairs of the body parts:
   detecting, for each one of the key-points of the first body part, the first direction region of that key-point based on a position of that key-point and a predefined shape and size of the first direction region from the spatial feature map of that pair;
   detecting, for each one of the key-points of the second body part, the second direction region of that key-point based on a position of that key-point and a predefined shape and size of the second direction region from the spatial feature map of that pair; and
   performing, for each one of the key-points of the first body part:
      computing, for each one of the key-points of the second body part, a coefficient distance between that key-point of the first body part and that key-point of the second body part; and
      put that key-point of the first body part and the key-point of the second body part having a smallest coefficient distance into a same key-point group as each other, and
wherein the coefficient distance between the key-point of the first body part and the key-point of the second body part represents how much different the direction represented by the first direction region of that key-point of the first body part is from the direction represented by the second direction region of that key-point of the second body part.

### Supplementary Note 3

The key-point associating apparatus according to supplementary note 2,
wherein the computation of the coefficient distance between the key-point of the first body part and the key-point of the second body part includes:
   computing a statistical value of pixel values within the first direction region of that key-point of the first body part as the direction represented by that first direction region;
   computing a statistical value of pixel values within the second direction region of that key-point of the second body part as the direction represented by that second direction region; and
   computing an absolute difference between the direction represented by that first direction region and the direction represented by that second direction region.

### Supplementary Note 4

The key-point associating apparatus according to supplementary note 3,
wherein the computation of the coefficient distance between the key-point of the first body part and the key-point of the second body part further includes adjusting the absolute difference by Euclid distance between those key-points.

### Supplementary Note 5

The key-point associating apparatus according to supplementary note 1,
wherein the position of the key-point is represented by 3D coordinates,
wherein, for each one of the predefined pairs of the body parts, a horizontal spatial feature map and a vertical spatial feature map are generated as the spatial feature maps of that pair,
wherein, in the horizontal spatial feature map, the first direction region and the second direction region that belong to a same person as each other represent a horizontal direction from the key-point of the first direction region to the key-point of the second direction region, and
wherein, in the vertical spatial feature map, the first direction region and the second direction region that belong to a same person as each other represent a vertical direction from the key-point of the first direction region to the key-point of the second direction region.

### Supplementary Note 6

The key-point associating apparatus according to supplementary note 5,
wherein the generation of the key-point groups includes, for each one of the predefined pairs of the body parts:
   detecting, for each one of the key-points of the first body part, the first direction region of that key-point based on a position of that key-point and a predefined shape and size of the first direction region from each of the horizontal spatial feature map and the vertical spatial feature map of that pair;
   detecting, for each one of the key-points of the second body part, the second direction region of that key-point based on a position of that key-point and a predefined shape and size of the second direction region from each of the horizontal spatial feature map and the vertical spatial feature map of that pair; and
   performing, for each one of the key-points of the first body part:
      computing, for each one of the key-points of the second body part, a coefficient distance between that key-point of the first body part and that key-point of the second body part:
      put that key-point of the first body part and the key-point of the second body part having a smallest coefficient distance into a same key-point group as each other, and
wherein the computation of the coefficient distance between the key-point of the first body part and the key-point of the second body part includes:
   computing, for each of the horizontal feature map and the vertical feature map, a statistical value of pixel values within the first direction region of that key-point of the first body part as the direction represented by that first direction region;
   computing, for each of the horizontal feature map and the vertical feature map, a statistical value of pixel values within the second direction region of that key-point of the second body part as the direction represented by that second direction region; and
   computing an absolute difference between the direction represented by that first direction region and the direction represented by that second direction region for each of the horizontal feature map and the vertical feature map; and
   computing a sum of the absolute differences.

### Supplementary Note 7

The key-point associating apparatus according to supplementary note 6,
wherein the computation of the coefficient distance between the key-point of the first body part and the key-point of the second body part further includes adjusting the sum of the absolute differences by Euclid distance between that key-point of the first body part and that key-point of the second body part.

### Supplementary Note 8

A key-point associating method performed by a computer, comprising:
acquiring a target image on which one or more persons are captured;
detecting key-points of the persons from the target image for each one of body parts of the person;
generating a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and
generating a key-point group, which includes the key-points of a same person as each other, for each one of the persons captured on the target image.

### Supplementary Note 9

The key-point associating method according to supplementary note 8,
wherein the generation of the key-point groups includes performing, for each one of the predefined pairs of the body parts:
   detecting, for each one of the key-points of the first body part, the first direction region of that key-point based on a position of that key-point and a predefined shape and size of the first direction region from the spatial feature map of that pair;
   detecting, for each one of the key-points of the second body part, the second direction region of that key-point based on a position of that key-point and a predefined shape and size of the second direction region from the spatial feature map of that pair; and
   performing, for each one of the key-points of the first body part:
      computing, for each one of the key-points of the second body part, a coefficient distance between that key-point of the first body part and that key-point of the second body part; and
      put that key-point of the first body part and the key-point of the second body part having a smallest coefficient distance into a same key-point group as each other, and
wherein the coefficient distance between the key-point of the first body part and the key-point of the second body part represents how much different the direction represented by the first direction region of that key-point of the first body part is from the direction represented by the second direction region of that key-point of the second body part.

### Supplementary Note 10

The key-point associating method according to supplementary note 9,
wherein the computation of the coefficient distance between the key-point of the first body part and the key-point of the second body part includes:
   computing a statistical value of pixel values within the first direction region of that key-point of the first body part as the direction represented by that first direction region;
   computing a statistical value of pixel values within the second direction region of that key-point of the second body part as the direction represented by that second direction region; and
   computing an absolute difference between the direction represented by that first direction region and the direction represented by that second direction region.

### Supplementary Note 11

The key-point associating method according to supplementary note 10,
wherein the computation of the coefficient distance between the key-point of the first body part and the key-point of the second body part further includes adjusting the absolute difference by Euclid distance between those key-points.

### Supplementary Note 12

The key-point associating method according to supplementary note 8,
wherein the position of the key-point is represented by 3D coordinates,
wherein, for each one of the predefined pairs of the body parts, a horizontal spatial feature map and a vertical spatial feature map are generated as the spatial feature maps of that pair,
wherein, in the horizontal spatial feature map, the first direction region and the second direction region that belong to a same person as each other represent a horizontal direction from the key-point of the first direction region to the key-point of the second direction region, and
wherein, in the vertical spatial feature map, the first direction region and the second direction region that belong to a same person as each other represent a vertical direction from the key-point of the first direction region to the key-point of the second direction region.

### Supplementary Note 13

The key-point associating method according to supplementary note 12,
wherein the generation of the key-point groups includes, for each one of the predefined pairs of the body parts:
   detecting, for each one of the key-points of the first body part, the first direction region of that key-point based on a position of that key-point and a predefined shape and size of the first direction region from each of the horizontal spatial feature map and the vertical spatial feature map of that pair;
   detecting, for each one of the key-points of the second body part, the second direction region of that key-point based on a position of that key-point and a predefined shape and size of the second direction region from each of the horizontal spatial feature map and the vertical spatial feature map of that pair; and
   performing, for each one of the key-points of the first body part:
      computing, for each one of the key-points of the second body part, a coefficient distance between that key-point of the first body part and that key-point of the second body part:
      put that key-point of the first body part and the key-point of the second body part having a smallest coefficient distance into a same key-point group as each other, and
wherein the computation of the coefficient distance between the key-point of the first body part and the key-point of the second body part includes:
   computing, for each of the horizontal feature map and the vertical feature map, a statistical value of pixel values within the first direction region of that key-point of the first body part as the direction represented by that first direction region;
   computing, for each of the horizontal feature map and the vertical feature map, a statistical value of pixel values within the second direction region of that key-point of the second body part as the direction represented by that second direction region; and
   computing an absolute difference between the direction represented by that first direction region and the direction represented by that second direction region for each of the horizontal feature map and the vertical feature map; and
   computing a sum of the absolute differences.

### Supplementary Note 14

The key-point associating method according to supplementary note 13,
wherein the computation of the coefficient distance between the key-point of the first body part and the key-point of the second body part further includes adjusting the sum of the absolute differences by Euclid distance between that key-point of the first body part and that key-point of the second body part.

### Supplementary Note 15

A non-transitory computer-readable storage medium storing a program that causes a computer to execute:
acquiring a target image on which one or more persons are captured;
detecting key-points of the persons from the target image for each one of body parts of the person;
generating a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and
generating a key-point group, which includes the key-points of a same person as each other, for each one of the persons captured on the target image.

### Supplementary Note 16

The storage medium according to supplementary note 15,
wherein the generation of the key-point groups includes performing, for each one of the predefined pairs of the body parts:
   detecting, for each one of the key-points of the first body part, the first direction region of that key-point based on a position of that key-point and a predefined shape and size of the first direction region from the spatial feature map of that pair;
   detecting, for each one of the key-points of the second body part, the second direction region of that key-point based on a position of that key-point and a predefined shape and size of the second direction region from the spatial feature map of that pair; and
   performing, for each one of the key-points of the first body part:
      computing, for each one of the key-points of the second body part, a coefficient distance between that key-point of the first body part and that key-point of the second body part; and
      put that key-point of the first body part and the key-point of the second body part having a smallest coefficient distance into a same key-point group as each other, and
wherein the coefficient distance between the key-point of the first body part and the key-point of the second body part represents how much different the direction represented by the first direction region of that key-point of the first body part is from the direction represented by the second direction region of that key-point of the second body part.

### Supplementary Note 17

The storage medium according to supplementary note 16,
wherein the computation of the coefficient distance between the key-point of the first body part and the key-point of the second body part includes:
   computing a statistical value of pixel values within the first direction region of that key-point of the first body part as the direction represented by that first direction region;
   computing a statistical value of pixel values within the second direction region of that key-point of the second body part as the direction represented by that second direction region; and
   computing an absolute difference between the direction represented by that first direction region and the direction represented by that second direction region.

### Supplementary Note 18

The storage medium according to supplementary note 17,
wherein the computation of the coefficient distance between the key-point of the first body part and the key-point of the second body part further includes adjusting the absolute difference by Euclid distance between those key-points.

### Supplementary Note 19

The storage medium according to supplementary note 15,
wherein the position of the key-point is represented by 3D coordinates,
wherein, for each one of the predefined pairs of the body parts, a horizontal spatial feature map and a vertical spatial feature map are generated as the spatial feature maps of that pair,
wherein, in the horizontal spatial feature map, the first direction region and the second direction region that belong to a same person as each other represent a horizontal direction from the key-point of the first direction region to the key-point of the second direction region, and
wherein, in the vertical spatial feature map, the first direction region and the second direction region that belong to a same person as each other represent a vertical direction from the key-point of the first direction region to the key-point of the second direction region.

### Supplementary Note 20

The storage medium according to supplementary note 17,
wherein the generation of the key-point groups includes, for each one of the predefined pairs of the body parts:
   detecting, for each one of the key-points of the first body part, the first direction region of that key-point based on a position of that key-point and a predefined shape and size of the first direction region from each of the horizontal spatial feature map and the vertical spatial feature map of that pair;
   detecting, for each one of the key-points of the second body part, the second direction region of that key-point based on a position of that key-point and a predefined shape and size of the second direction region from each of the horizontal spatial feature map and the vertical spatial feature map of that pair; and
   performing, for each one of the key-points of the first body part:
      computing, for each one of the key-points of the second body part, a coefficient distance between that key-point of the first body part and that key-point of the second body part:
      put that key-point of the first body part and the key-point of the second body part having a smallest coefficient distance into a same key-point group as each other, and
wherein the computation of the coefficient distance between the key-point of the first body part and the key-point of the second body part includes:
   computing, for each of the horizontal feature map and the vertical feature map, a statistical value of pixel values within the first direction region of that key-point of the first body part as the direction represented by that first direction region;
   computing, for each of the horizontal feature map and the vertical feature map, a statistical value of pixel values within the second direction region of that key-point of the second body part as the direction represented by that second direction region; and
   computing an absolute difference between the direction represented by that first direction region and the direction represented by that second direction region for each of the horizontal feature map and the vertical feature map; and
   computing a sum of the absolute differences.

### Supplementary Note 21

The storage medium according to supplementary note 20,
wherein the computation of the coefficient distance between the key-point of the first body part and the key-point of the second body part further includes adjusting the sum of the absolute differences by Euclid distance between that key-point of the first body part and that key-point of the second body part.

### REFERENCE SIGNS LIST

10 target image
20 key-point
30 spatial feature map
32 direction region
40 key-point group
50 horizontal spatial feature map
60 vertical spatial feature map
70 feature extracting model
72 first model
74 second model
80 person
1000 computer
1020 bus
1040 processor
1060 memory
1080 storage device
1100 input/output interface
1120 network interface
2000 key-point associating apparatus
2020 acquiring unit
2040 key-point detecting unit
2060 feature map generating unit
2080 key-point associating unit

What is claimed is:

1. A key-point associating apparatus comprising:
at least one memory that is configured to store instructions; and
at least one processor that is configured to execute the instructions to:
acquire a target image on which one or more persons are captured;
detect key-points of the persons from the target image for each one of body parts of the person;
generate a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and
generate a key-point group, which includes the key-points of a same person as each other, for each one of the persons captured on the target image.

2. The key-point associating apparatus according to claim 1,
wherein the generation of the key-point groups includes performing, for each one of the predefined pairs of the body parts:
detecting, for each one of the key-points of the first body part, the first direction region of that key-point based on a position of that key-point and a predefined shape and size of the first direction region from the spatial feature map of that pair;
detecting, for each one of the key-points of the second body part, the second direction region of that key-point based on a position of that key-point and a predefined shape and size of the second direction region from the spatial feature map of that pair; and
performing, for each one of the key-points of the first body part:
computing, for each one of the key-points of the second body part, a coefficient distance between that key-point of the first body part and that key-point of the second body part; and
put that key-point of the first body part and the key-point of the second body part having a smallest coefficient distance into a same key-point group as each other, and
wherein the coefficient distance between the key-point of the first body part and the key-point of the second body part represents how much different the direction represented by the first direction region of that key-point of the first body part is from the direction represented by the second direction region of that key-point of the second body part.

3. The key-point associating apparatus according to claim 2,
wherein the computation of the coefficient distance between the key-point of the first body part and the key-point of the second body part includes:
computing a statistical value of pixel values within the first direction region of that key-point of the first body part as the direction represented by that first direction region;
computing a statistical value of pixel values within the second direction region of that key-point of the second body part as the direction represented by that second direction region; and
computing an absolute difference between the direction represented by that first direction region and the direction represented by that second direction region.

4. The key-point associating apparatus according to claim 3,
wherein the computation of the coefficient distance between the key-point of the first body part and the key-point of the second body part further includes adjusting the absolute difference by Euclid distance between those key-points.

5. The key-point associating apparatus according to claim 1,
wherein the position of the key-point is represented by 3D coordinates,
wherein, for each one of the predefined pairs of the body parts, a horizontal spatial feature map and a vertical spatial feature map are generated as the spatial feature maps of that pair,
wherein, in the horizontal spatial feature map, the first direction region and the second direction region that belong to a same person as each other represent a horizontal direction from the key-point of the first direction region to the key-point of the second direction region, and
wherein, in the vertical spatial feature map, the first direction region and the second direction region that belong to a same person as each other represent a vertical direction from the key-point of the first direction region to the key-point of the second direction region.

6. The key-point associating apparatus according to claim 5,
wherein the generation of the key-point groups includes, for each one of the predefined pairs of the body parts:
detecting, for each one of the key-points of the first body part, the first direction region of that key-point based on a position of that key-point and a predefined shape and size of the first direction region from each of the horizontal spatial feature map and the vertical spatial feature map of that pair;
detecting, for each one of the key-points of the second body part, the second direction region of that key-point based on a position of that key-point and a predefined shape and size of the second direction region from each of the horizontal spatial feature map and the vertical spatial feature map of that pair; and
performing, for each one of the key-points of the first body part:
computing, for each one of the key-points of the second body part, a coefficient distance between that key-point of the first body part and that key-point of the second body part;
put that key-point of the first body part and the key-point of the second body part having a smallest coefficient distance into a same key-point group as each other, and
wherein the computation of the coefficient distance between the key-point of the first body part and the key-point of the second body part includes:
computing, for each of the horizontal feature map and the vertical feature map, a statistical value of pixel values within the first direction region of that key-point of the first body part as the direction represented by that first direction region;
computing, for each of the horizontal feature map and the vertical feature map, a statistical value of pixel values within the second direction region of that key-point of the second body part as the direction represented by that second direction region; and
computing an absolute difference between the direction represented by that first direction region and the direction represented by that second direction region for each of the horizontal feature map and the vertical feature map; and
computing a sum of the absolute differences.

7. The key-point associating apparatus according to claim 6,
wherein the computation of the coefficient distance between the key-point of the first body part and the key-point of the second body part further includes adjusting the sum of the absolute differences by Euclid distance between that key-point of the first body part and that key-point of the second body part.

8. A key-point associating method performed by a computer, comprising:
acquiring a target image on which one or more persons are captured;
detecting key-points of the persons from the target image for each one of body parts of the person;
generating a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and
generating a key-point group, which includes the key-points of a same person as each other, for each one of the persons captured on the target image.

9. The key-point associating method according to claim 8,
wherein the generation of the key-point groups includes performing, for each one of the predefined pairs of the body parts:
detecting, for each one of the key-points of the first body part, the first direction region of that key-point based on a position of that key-point and a predefined shape and size of the first direction region from the spatial feature map of that pair;
detecting, for each one of the key-points of the second body part, the second direction region of that key-point based on a position of that key-point and a predefined shape and size of the second direction region from the spatial feature map of that pair; and
performing, for each one of the key-points of the first body part:
computing, for each one of the key-points of the second body part, a coefficient distance between that key-point of the first body part and that key-point of the second body part; and
put that key-point of the first body part and the key-point of the second body part having a smallest coefficient distance into a same key-point group as each other, and
wherein the coefficient distance between the key-point of the first body part and the key-point of the second body part represents how much different the direction represented by the first direction region of that key-point of the first body part is from the direction represented by the second direction region of that key-point of the second body part.

10. The key-point associating method according to claim 9,
wherein the computation of the coefficient distance between the key-point of the first body part and the key-point of the second body part includes:
computing a statistical value of pixel values within the first direction region of that key-point of the first body part as the direction represented by that first direction region;
computing a statistical value of pixel values within the second direction region of that key-point of the second body part as the direction represented by that second direction region; and
computing an absolute difference between the direction represented by that first direction region and the direction represented by that second direction region.

11. The key-point associating method according to claim 10,
wherein the computation of the coefficient distance between the key-point of the first body part and the key-point of the second body part further includes adjusting the absolute difference by Euclid distance between those key-points.

12. The key-point associating method according to claim 8,
wherein the position of the key-point is represented by 3D coordinates,
wherein, for each one of the predefined pairs of the body parts, a horizontal spatial feature map and a vertical spatial feature map are generated as the spatial feature maps of that pair,
wherein, in the horizontal spatial feature map, the first direction region and the second direction region that belong to a same person as each other represent a horizontal direction from the key-point of the first direction region to the key-point of the second direction region, and
wherein, in the vertical spatial feature map, the first direction region and the second direction region that belong to a same person as each other represent a vertical direction from the key-point of the first direction region to the key-point of the second direction region.

13. The key-point associating method according to claim 12,
wherein the generation of the key-point groups includes, for each one of the predefined pairs of the body parts:
detecting, for each one of the key-points of the first body part, the first direction region of that key-point based on a position of that key-point and a predefined shape and size of the first direction region from each of the horizontal spatial feature map and the vertical spatial feature map of that pair;
detecting, for each one of the key-points of the second body part, the second direction region of that key-point based on a position of that key-point and a predefined shape and size of the second direction region from each of the horizontal spatial feature map and the vertical spatial feature map of that pair; and
performing, for each one of the key-points of the first body part:
computing, for each one of the key-points of the second body part, a coefficient distance between that key-point of the first body part and that key-point of the second body part;
put that key-point of the first body part and the key-point of the second body part having a smallest coefficient distance into a same key-point group as each other, and
wherein the computation of the coefficient distance between the key-point of the first body part and the key-point of the second body part includes:
computing, for each of the horizontal feature map and the vertical feature map, a statistical value of pixel values within the first direction region of that key-point of the first body part as the direction represented by that first direction region;
computing, for each of the horizontal feature map and the vertical feature map, a statistical value of pixel values within the second direction region of that key-point of the second body part as the direction represented by that second direction region; and
computing an absolute difference between the direction represented by that first direction region and the direction represented by that second direction region for each of the horizontal feature map and the vertical feature map; and
computing a sum of the absolute differences.

14. The key-point associating method according to claim 13,
wherein the computation of the coefficient distance between the key-point of the first body part and the key-point of the second body part further includes adjusting the sum of the absolute differences by Euclid distance between that key-point of the first body part and that key-point of the second body part.

15. A non-transitory computer-readable storage medium storing a program that causes a computer to execute:
acquiring a target image on which one or more persons are captured;
detecting key-points of the persons from the target image for each one of body parts of the person;
generating a spatial feature map for each one of predefined pairs of the body parts using the target image, the spatial feature map of the pair of the body parts including a first direction region for each one of the key-points that represents a first body part of that pair and a second direction region for each one of the key-points that represents a second body part of that pair, the first direction region and the second direction region that belong to a same person as each other representing a direction from the key-point of the first direction region to the key-point of the second direction region; and
generating a key-point group, which includes the key-points of a same person as each other, for each one of the persons captured on the target image.

16. The storage medium according to claim 15,
wherein the generation of the key-point groups includes performing, for each one of the predefined pairs of the body parts:
detecting, for each one of the key-points of the first body part, the first direction region of that key-point based on a position of that key-point and a predefined shape and size of the first direction region from the spatial feature map of that pair;
detecting, for each one of the key-points of the second body part, the second direction region of that key-point based on a position of that key-point and a predefined shape and size of the second direction region from the spatial feature map of that pair; and
performing, for each one of the key-points of the first body part:
computing, for each one of the key-points of the second body part, a coefficient distance between that key-point of the first body part and that key-point of the second body part; and
put that key-point of the first body part and the key-point of the second body part having a smallest coefficient distance into a same key-point group as each other, and
wherein the coefficient distance between the key-point of the first body part and the key-point of the second body part represents how much different the direction represented by the first direction region of that key-point of the first body part is from the direction represented by the second direction region of that key-point of the second body part.

17. The storage medium according to claim 16,
wherein the computation of the coefficient distance between the key-point of the first body part and the key-point of the second body part includes:
computing a statistical value of pixel values within the first direction region of that key-point of the first body part as the direction represented by that first direction region;
computing a statistical value of pixel values within the second direction region of that key-point of the second body part as the direction represented by that second direction region; and
computing an absolute difference between the direction represented by that first direction region and the direction represented by that second direction region.

18. The storage medium according to claim 17,
wherein the computation of the coefficient distance between the key-point of the first body part and the key-point of the second body part further includes adjusting the absolute difference by Euclid distance between those key-points.

19. The storage medium according to claim 15,
wherein the position of the key-point is represented by 3D coordinates,
wherein, for each one of the predefined pairs of the body parts, a horizontal spatial feature map and a vertical spatial feature map are generated as the spatial feature maps of that pair,
wherein, in the horizontal spatial feature map, the first direction region and the second direction region that belong to a same person as each other represent a horizontal direction from the key-point of the first direction region to the key-point of the second direction region, and
wherein, in the vertical spatial feature map, the first direction region and the second direction region that belong to a same person as each other represent a vertical direction from the key-point of the first direction region to the key-point of the second direction region.

20. The storage medium according to claim 17,
wherein the generation of the key-point groups includes, for each one of the predefined pairs of the body parts:
detecting, for each one of the key-points of the first body part, the first direction region of that key-point based on a position of that key-point and a predefined shape and size of the first direction region from each of the horizontal spatial feature map and the vertical spatial feature map of that pair;
detecting, for each one of the key-points of the second body part, the second direction region of that key-point based on a position of that key-point and a predefined shape and size of the second direction region from each of the horizontal spatial feature map and the vertical spatial feature map of that pair; and
performing, for each one of the key-points of the first body part:
computing, for each one of the key-points of the second body part, a coefficient distance between that key-point of the first body part and that key-point of the second body part;
put that key-point of the first body part and the key-point of the second body part having a smallest coefficient distance into a same key-point group as each other, and
wherein the computation of the coefficient distance between the key-point of the first body part and the key-point of the second body part includes:
computing, for each of the horizontal feature map and the vertical feature map, a statistical value of pixel values within the first direction region of that key-point of the first body part as the direction represented by that first direction region;
computing, for each of the horizontal feature map and the vertical feature map, a statistical value of pixel values within the second direction region of that key-point of the second body part as the direction represented by that second direction region; and
computing an absolute difference between the direction represented by that first direction region and the direction represented by that second direction region for each of the horizontal feature map and the vertical feature map; and
computing a sum of the absolute differences.

21. (canceled)
